(19) United States
(12) Patent Application Publication
(10) Pub. No.: US 2012/0134152 A1
(43) Pub. Date: May 31, 2012

(54) LIGHT SOURCE FOR CRYSTAL LAMP

(76) Inventors: Zhi-Ting YE, Miao Li County (TW); Kuo-Jui Huang, Tai Chung County (TW)

(21) Appl. No.: 13/304,032

(22) Filed: Nov. 23, 2011

(30) Foreign Application Priority Data
Nov. 30, 2010 (TW) 099141457

(51) Int. Cl. F21V 5/04

(52) U.S. Cl. 362/235

(57) ABSTRACT

A light source for a crystal lamp has a lens structure, at least one light-emitting element, and a plurality of prism structures. The lens structure has a bottom surface and an arc surface connected with a periphery of the bottom surface, and a notch structure is formed on the bottom surface and concave towards the inside of the lens structure. The light-emitting element is disposed inside the notch structure, and the prism structures are formed on the arc surface. Each of the prism structures deflects the light emitted by the light-emitting element and passing through the arc surface of the lens structure.

### BACKGROUND OF THE INVENTION

a. Field of the Invention

The invention relates to a light source for a crystal lamp.

b. Description of the Related Art

Referring to FIG. 1, a light source 102 of a conventional crystal lamp 100 is surrounded by multiple crystal polyhedrons each having multiple light-refraction walls. Though each of the crystal polyhedrons is a light dispersion element, the crystal lamp 100 fails to provide splendid and colorful visual effects because emitting light I of the light source 102 scatters in all directions and the emitting light I is refracted to a limited extent through the light refraction walls sloping at different angles. Further, as shown in FIG. 2, a side wall of a crystal lamp 200 is shaped to form a thin line 202 to enhance light-refraction effects. However, such design enhances light-refraction effects only to a limited extent. Further, Taiwan patent no. M255922 discloses a fiber design where multiple micro structures are formed on a fiber surface to enhance light-refraction effects.

Referring to FIGS. 3A, 3B and 3C, FIG. 3A shows a lamp bulb having a high color rendering index (Ra) light source, FIG. 3B shows a lamp bulb having multiple directional light source, and FIG. 3C shows a conventional tungsten lamp having a thin-lined light source. Typically, a lamp bulb having multiple directional light sources (FIG. 3B) or a thin-lined light source (FIG. 3C) may produce better refraction effects compared with a lamp bulb having a high color rendering index (Ra) light source (FIG. 3A). Therefore, the lamp bulbs shown in FIG. 3B and FIG. 3C are more capable of providing splendid and colorful visual effects. Specifically, a crystal polyhedron may function as a light dispersion prism, and the degree of light dispersion depends on the prism material, prism shape, wavelength and incident direction of light, etc. Since multiple directional light sources and a thin-lined light source may provide highly directional light emission and are widely spread in space, enhanced light dispersion effects are allowed to be produced.

### BRIEF SUMMARY OF THE INVENTION

The invention provides a light source for a crystal lamp in the form of multiple point light sources to enhance light dispersion and division effects and allow the crystal lamp to produce splendid and colorful visual effects.

Other objects and advantages of the invention may be further illustrated by the technical features broadly embodied and described as follows. In order to achieve one or part of or all of the above merits, an embodiment of the invention provides a light source for a crystal lamp having a lens structure, at least one light-emitting element, and a plurality of prism structures. The lens structure has a bottom surface and an arc surface connected with a periphery of the bottom surface, and a notch structure is formed on the bottom surface and concave towards the inside of the lens structure. The light-emitting element is disposed inside the notch structure, and the prism structures are formed on the arc surface. Each of the prism structures deflects the light emitted by the light-emitting element and passing through the arc surface of the lens structure.

In one embodiment, the lens structure is in the shape of a semi-sphere, the bottom surface is a substantially planar surface, and the arc surface is a circular arc surface or an elliptical arc surface.

In one embodiment, the shape of the notch structure is identical to the shape of the lens structure.

In one embodiment, each of the prism structures forms the shape of at least one of a cone and a pyramid.

In one embodiment, each of the prism structures is in the shape of a triangular pyramid, and an apex angle of the triangular pyramid is in the range of 80 to 100 degrees.

In one embodiment, the notch structure has an arc-shaped inner wall, and a radius of curvature of the arc surface of the lens structure is larger than a radius of curvature of the arc-shaped inner wall.

In one embodiment, a base is disposed at the bottom of the lens structure to support the light-emitting element.

According to the above embodiment, the inner wall of the notch structure is allowed to deflect the light emitted by the light-emitting element at a comparatively large angle to scatter the light, and the light passing through the arc surface of the lens structure are deflected or totally reflected by the prism structures to allow each prism structure to function as an independent point light source. Therefore, a single point light source (light-emitting element) is transformed into multiple point light sources (multiple light-emitting prism structures). Since multiple point light sources formed by the light-emitting prism structures are allowed to provide highly directional light emission and widely spread over different regions in space, light dispersion and division effects of a crystal lamp quipped with the light source are considerably enhanced. In that case, emitting light from each prism structure passes through a crystal polyhedron to produce splendid and colorful visual effects. Accordingly, the simple configuration of the light source for a crystal lamp allows for reduced fabrication costs to produce splendid and colorful visual effects.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a conventional crystal lamp having multiple crystal polyhedrons

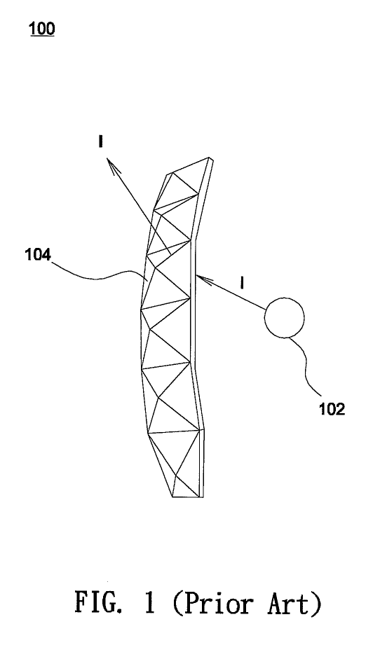

FIG. 2 shows a schematic diagram illustrating another conventional crystal lamp having multiple crystal polyhedrons

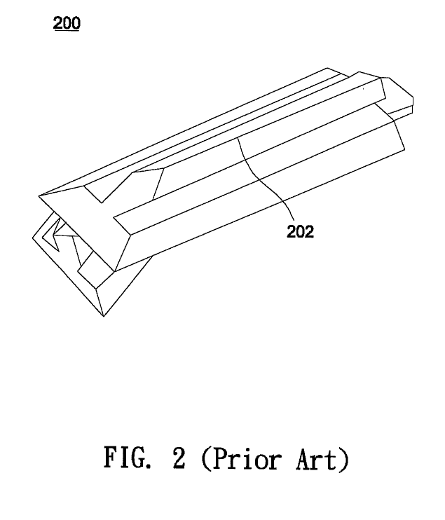

FIGS. 3A, 3B and 3C show schematic diagrams illustrating different types of conventional light sources for a crystal lamp.

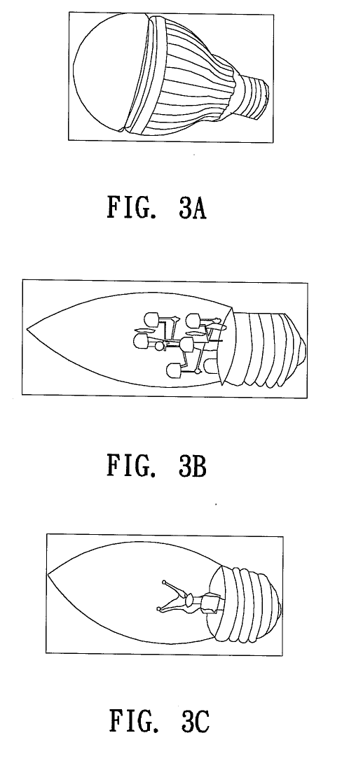

FIG. 4 shows a schematic diagram of a light source for a crystal lamp according to an embodiment of the invention.

FIG. 5 shows a schematic diagram of a light source for a crystal lamp according to another embodiment of the invention.

FIG. 6A shows a schematic diagram illustrating light-emitting angles and a light-emitting distribution of a light source for a crystal lamp according to an embodiment of the invention.

FIG. 6B shows a schematic diagram illustrating light-emitting angles and a light-emitting distribution of a conventional light source for a crystal lamp.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

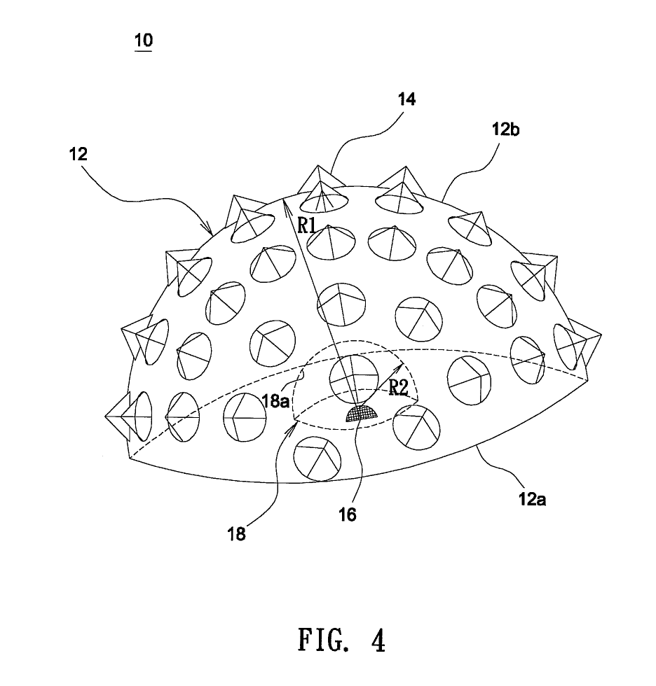

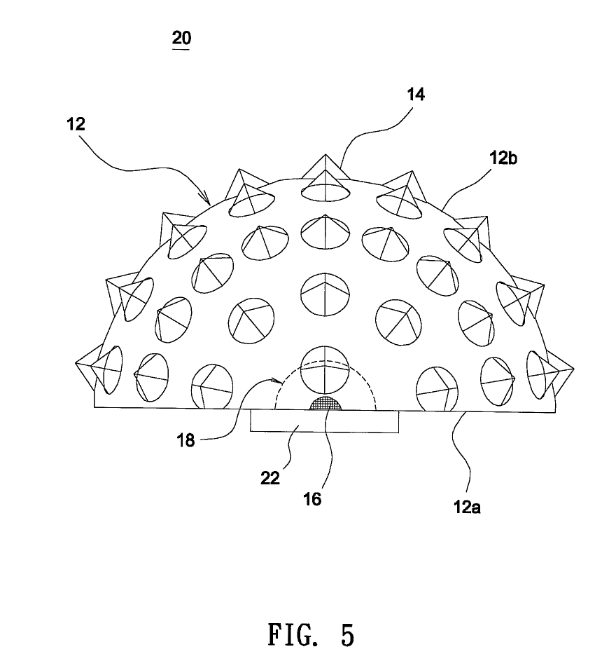

FIG. 4 shows a schematic diagram of a light source for a crystal lamp according to an embodiment of the invention. Referring to FIG. 4, a light source 10 for a crystal lamp includes a lens structure 12, a plurality of prism structures 14, and a light-emitting element 16. The lens structure 12 may have a bottom surface 12a and an arc surface 12b connected with a periphery of the bottom surface 12a. In this embodiment, the arc surface 12b is connected with an entire periphery of the bottom surface 12a. The shape of the lens structure 12 is not restricted. For example, the lens structure 12 may be in the shape of a semi-sphere, the bottom surface 12a is a substantially planar surface in the shape of a circle or an ellipse, and the arc surface 12b is a circular arc surface or an elliptical arc surface. Besides, a notch structure 18 is formed on the bottom surface 12a and concave towards the inside of the lens structure 12, and the light-emitting element 16 such as an LED is disposed inside the notch structure 18. The shape of the notch structure 18 may be identical to the shape of the lens structure 12 but is not restricted. For example, in case the lens structure 12 is in the shape of a semi-sphere, the notch structure 18 may similarly have a shape of a semi-sphere. Multiple prism structures 14 are distributed on the arc surface 12b. In this embodiment, each of the prism structures 14 forms the shape of a triangular pyramid, and an apex angle of the triangular pyramid is in the range of 80 to 100 degrees. Certainly, the shape of the prism structure 14 is not restricted, and may be a pyramid or a cone to provide light-deflection effects. In one embodiment, the notch structure 18 has an arc-shaped inner wall 18a, and a radius of curvature R1 of the arc surface 12b of the lens structure 12 is larger than a radius of curvature R2 of the arc-shaped inner wall 18a (R1>R2). Referring to FIG. 5, in an alternate embodiment, a light source 20 for a crystal lamp further includes a base 22 disposed at the bottom of the lens structure 12 to support the light-emitting element 16.

According to the above embodiments, the inner wall 18a of the notch structure 18 is allowed to deflect the light emitted by the light-emitting element 16 at a comparatively large angle to scatter the light, and the light passing through the arc surface 12b of the lens structure 12 are deflected or totally reflected by the prism structures 14 to allow each prism structure 14 to function as an independent point light source. Therefore, a single point light source (light-emitting element 16) is transformed into multiple point light sources (multiple light-emitting prism structures 14). Since multiple point light sources formed by the light-emitting prism structures 14 are allowed to provide highly directional light emission and widely spread over different regions in space, light scattering and division effects of a crystal lamp quipped with the light source 10 are considerably enhanced. In that case, emitting light from each prism structure 14 passes through a crystal polyhedron to produce splendid and colorful visual effects. Accordingly, the simple configuration of the light source 10 for a crystal lamp allows for reduced fabrication costs to produce splendid and colorful visual effects.

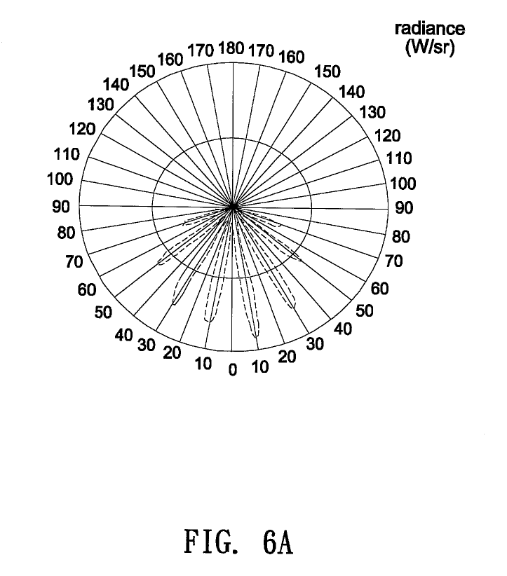

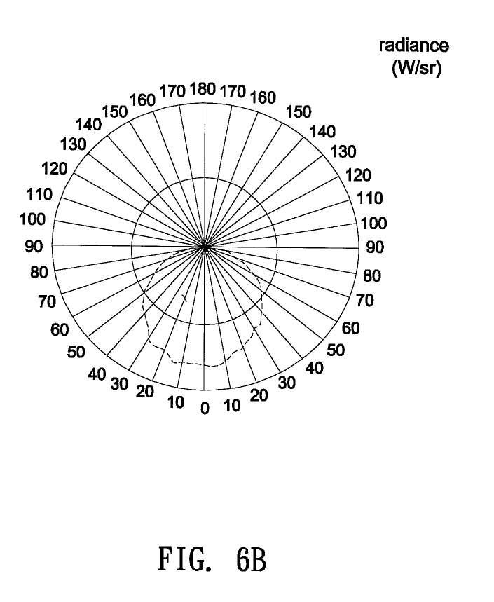

FIG. 6A shows a schematic diagram illustrating light-emitting angles and a light-emitting distribution of a light source for a crystal lamp according to an embodiment of the invention. FIG. 6B shows a schematic diagram illustrating light-emitting angles and a light-emitting distribution of a conventional light source for a crystal lamp. Compared FIG. 6A with FIG. 6B, it can be clearly seen a different light-emitting distribution as a result of multiple point light sources and improved light dispersion effects are provided according to the embodiment of the invention. Further, by adjusting the distribution, size or surface inclined angle of the prism structures 14 and the notch structure 18, light-emitting characteristics and dispersion effects of multiple point light sources are optimized.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred.

What is claimed is:

1. A light source for a crystal lamp, comprising:
a lens structure having a bottom surface and an arc surface connected with a periphery of the bottom surface, wherein a notch structure is formed on the bottom surface and concave towards the inside of the lens structure;
at least one light-emitting element disposed inside the notch structure; and
a plurality of prism structures formed on the arc surface, wherein each of the prism structures deflects the light emitted by the light-emitting element and passing through the arc surface of the lens structure.

2. The light source for a crystal lamp as claimed in claim 1, wherein the lens structure is in the shape of a semi-sphere.

3. The light source for a crystal lamp as claimed in claim 1, wherein the bottom surface is a substantially planar surface, and the arc surface is a circular arc surface or an elliptical arc surface.

4. The light source for a crystal lamp as claimed in claim 1, wherein the shape of the notch structure is identical to the shape of the lens structure.

5. The light source for a crystal lamp as claimed in claim 1, wherein the notch structure is in the shape of a semi-sphere.

6. The light source for a crystal lamp as claimed in claim 1, wherein each of the prism structures forms the shape of at least one of a cone and a pyramid.

7. The light source for a crystal lamp as claimed in claim 1, wherein each of the prism structures is in the shape of a triangular pyramid, and an apex angle of the triangular pyramid is in the range of 80 to 100 degrees.

8. The light source for a crystal lamp as claimed in claim 1, wherein the notch structure has an arc-shaped inner wall, and a radius of curvature of the arc surface of the lens structure is larger than a radius of curvature of the arc-shaped inner wall.

9. The light source for a crystal lamp as claimed in claim 1, further comprising:
a base disposed at the bottom of the lens structure to support the light-emitting element.

10. The light source for a crystal lamp as claimed in claim 1, wherein the light-emitting element comprises an LED.
